(19) United States
(12) Patent Application Publication
(10) Pub. No.: US 2003/0116971 A1
(43) Pub. Date: Jun. 26, 2003

(54) Method and apparatus for an automatic revolution of a floating device

(76) Inventor: Pichit Likitcheva, Praves Bangkok (TH)

Correspondence Address: Ladas & Parry, 26 West 61 Street, New York, NY, 10023, US

(21) Appl. No.: 10/032,391

(22) Filed: Dec. 21, 2001

(51) Int. Cl. H02P 9/04; F03B 13/10

(52) U.S. Cl. 290/53

(57) ABSTRACT

An apparatus and the method thereof comprising two floating devices of different size operating in tandem. The floating devices of the same design have their respective ends made from materials of different densities to keep the devices in submerged state when put in a liquid-filled container. An automatic revolution of the floating device is achieved when the balancing status of the larger floating device is tilted by the smaller floating device.

### BACKGROUND OF THE INVENTION

Through out the history of mankind there have been uncountable proposals to harness the forces of nature; however, most of those previous attempts failed to produce any fruitful result. Nevertheless, some recent theories including the ones proposed by the present inventor as disclosed in the U.S. Pat. No. 6,019,055, wherein the gravitation force on a floating platform could be diverted to various other locations in order to create a more balanced force distribution on the floating platform, and another as appeared in the U.S. patent application Ser. No. 09/910,693, also by the present inventor, which disclosed a method and apparatus that utilized the gravitation force to create a horizontal movement of a movable object by redirecting its resultant to various pre-designated locations in order to create a counter force on the original point of application, confirmed that there are some theories that could be put into practical uses.

### SUMMARY OF THE INVENTION

It is an objective of the present invention to provide a method and apparatus for an automatic and continuous revolution of a floating device while being under a buoyancy state.

In accordance with the present invention a floating oblong device is capable of revolving around its horizontal axis due to the difference in density of its two extremities. The said floating device is being contained within a light-weighted perforated tube in order for it to be able to move freely in its longitudinal direction, and the whole unit is being submerged in a liquid-filled container. However, in order to ensure the continuation of the movement after the initial revolving of the unit, the method and apparatus in accordance with the present invention also requires another similar unit of the said apparatus, but with a smaller size and with an opposing polarity to the first unit, to operate in tandem with the said first unit.

An apparatus of the present invention will be able to provide an unending source of energy for various applications without having to rely upon any outside force.

### BRIEF DESCRIPTION OF THE DRAWINGS

FIG. 1 is a schematic view of a floating device of the present invention in its basic form.

FIG. 2 is a schematic view of an open-ended light-weighted perforated tube for the containment of the floating device shown in FIG. 1.

FIGS. 3 and 4 are the schematic views of an apparatus in accordance with the present invention under two different working situations.

FIGS. 5 and 6 are the schematic views of an apparatus in accordance with the present invention wherein two units, one large and one small, of the devices shown in FIGS. 1-4 are operating in tandem as a single unit to generate a revolving movement automatically.

FIG. 7 is a schematic view of the floating device shown in FIGS. 5 and 6 installed inside a liquid-filled container with a specially-designed mechanism for further work applications.

FIGS. 8 and 9 are the schematic front and side views respectively of the apparatus in accordance with the present invention shown in FIG. 7.

FIG. 10 shows the general concept of another apparatus of the same inventor that could be combined with the floating device of the present invention for a more value-added work application.

FIG. 11 shows the general concept of the association between the floating apparatus of the present invention and the apparatus in FIG. 10.

### DETAILED DESCRIPTION OF THE PREFERED EMBODIMENTS

The illustrative embodiments of the apparatus for an automatic and continuous revolution of a floating device and the method of operation in accordance with the present invention will be explained in detail with reference to the drawings.

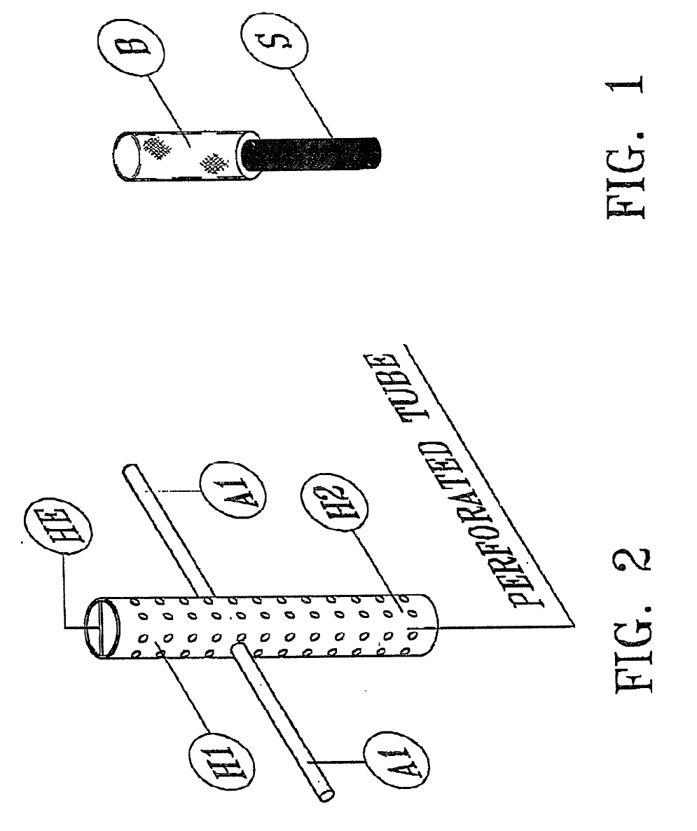

As shown in FIG. 1 the floating device in accordance with the present invention consists of two opposing sections of equal length B,S. Section B is made from lighter material for buoyancy such as a pocket of air and has a larger volume, wherein section S is made from heavier and more dense material with lower volume than section B. Under normal submerged state of the floating device the heavier section S will keep the whole unit at a position where the extreme end of section B is just below the surface of the liquid when being submerged in the container.

FIG. 2 is a light-weighted perforated tube for the containment of floating device in FIG. 1. In accordance with the present invention the perforated tube is divided into a shorter section H1, and a longer section H2, with a ratio of approximately 1:2 in length. At the adjoining location between the said two sections of the perforated tube two rods A1, A1, are connected to the outer wall on either side of the tube to act as an axis for the revolution of the floating device. Stopper HE at each end of sections H1, H2 limit the longitudinal movement of the floating device within the perforated tube.

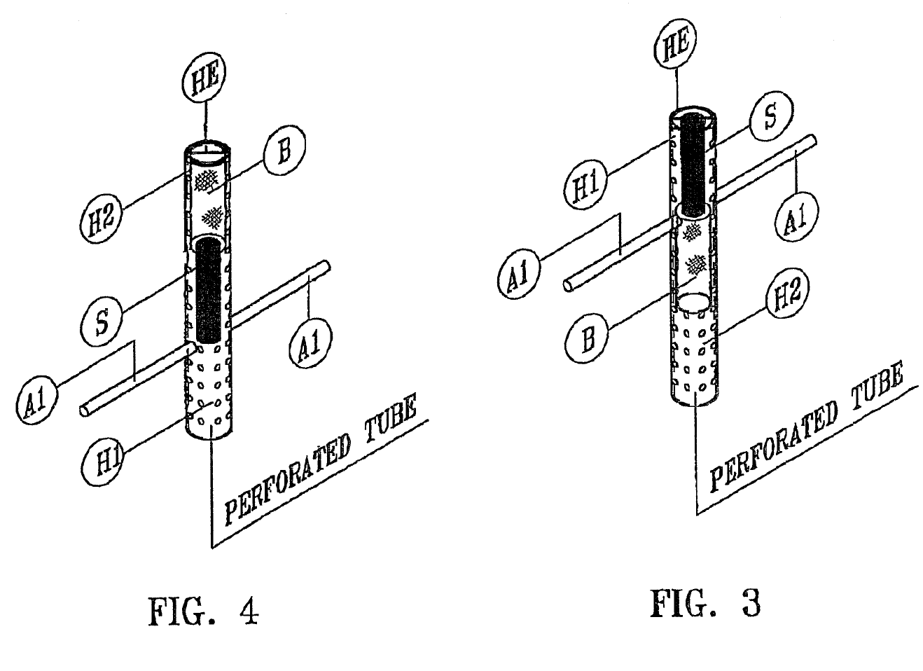

In FIG. 3 the floating device of the present invention is installed within the perforated tube of FIG. 2 with its heavier section S being forced to float up to reach the limit of tube section H1 at stopper HE by section B in accordance with the buoyancy principle. It is to be noted that the length of floating device heavier section S is the same as that of perforated tube section H1. And after the initial stage as shown in FIG. 3 the whole unit of the apparatus of the present invention will be forced by the heavier section S to turn upside down to reach a state as shown in FIG. 4. Since the perforated tube section H2 is two times the length of section H1 therefore both sections of the floating device B,S will be situated within section H2 of the perforated tube, and the whole unit will be at this status until being triggered to trip its balance by another inventive step of the present invention which will be explained as follow.

In accordance with the present invention the floating device as in the position shown in FIG. 4 will be able to turn or revolve automatically when operate in tandem with another unit of similar design but with approximately half the size of the original unit. As shown in FIG. 5 the small perforated tube of the same length is set along side the large perforated tube, but with opposite polarity, in order to tilt the balance of the larger unit of FIG. 4.

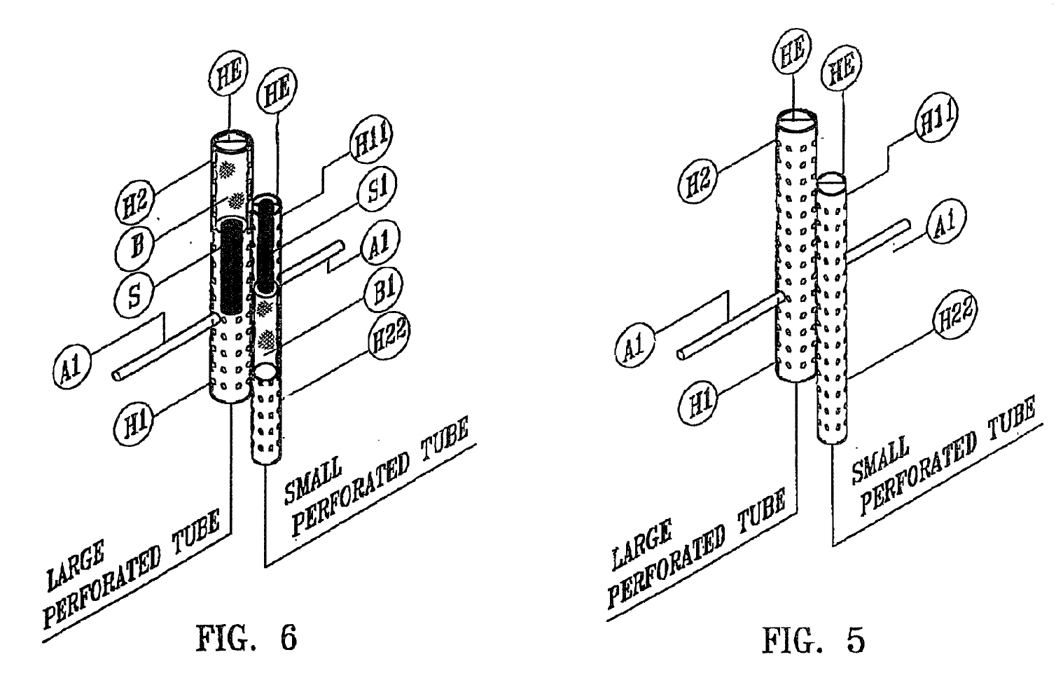

From the axis of rotation at rods A1, A1, the upper part of the whole tandem unit shown in FIG. 5 and FIG. 6 consist of larger tube long section H2, with its floating device in the position as shown in FIG. 4, and smaller tube short section H11, with its own small floating device as shown; while the bottom part of the whole tandem unit consist of larger tube short section H1 and smaller tube long section H22, respectively. It is to be noted that, for the small perforated tube, the floating device heavy section S1 is also being forced to float up to reach its stopper H11 by its own lighter section B1 below, and therefore making the heavy sections S and S1 of both larger and smaller units to be on the same level when being put under a buoyancy state. Accordingly the revolving actions of the large unit and small unit as explained herein will continue to counteract with each other to create an automatic revolution continuously.

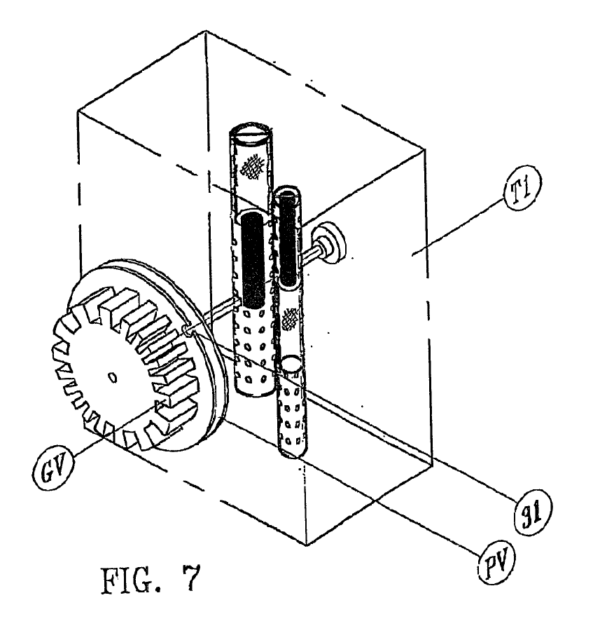

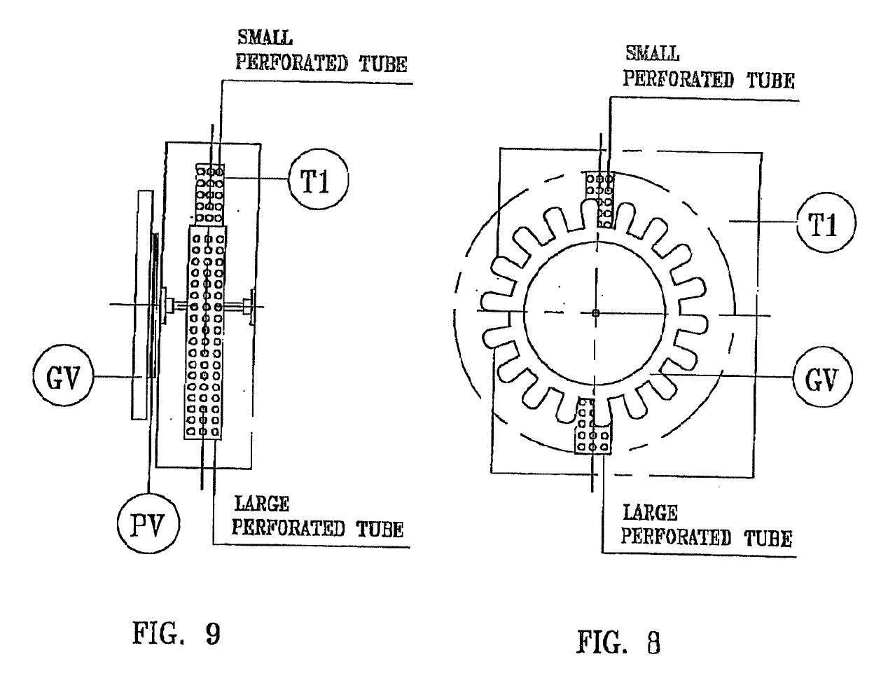

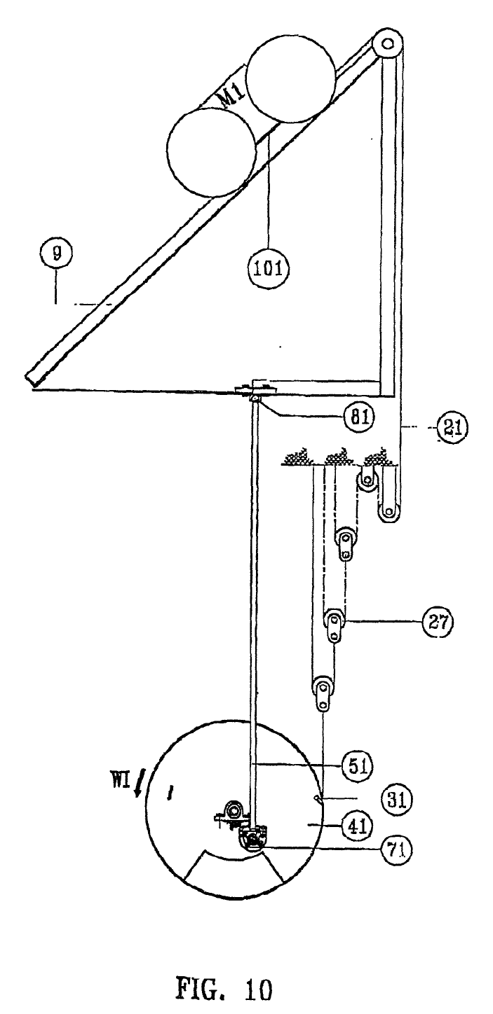

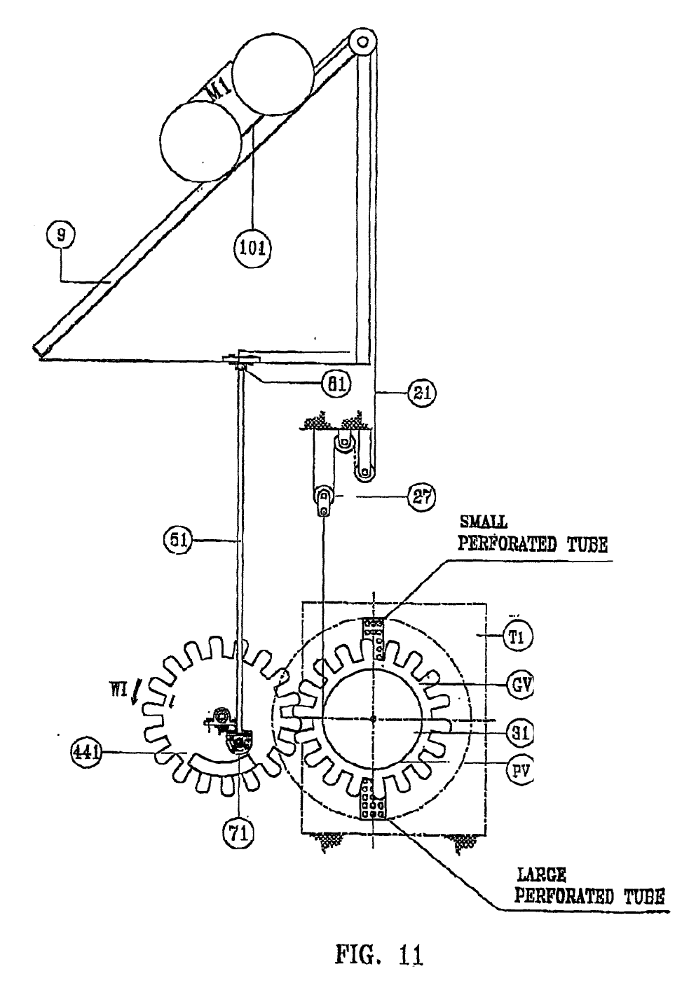

FIGS. 7, 8 and 9 show the floating device in accordance with the present invention under a ready to operate state, wherein the tandem unit of FIG. 6 has been installed for free rotation inside a liquid-filled container T1 between its two side walls. One of the rods A1 of the floating unit is protruding through one of the container's side wall for the installation of a suitable mechanism such as a set of sprocket GV and wheel PV, which includes a rope or sling-fixing dent 31 on its perimeter, for further work application that will be explained in detail with reference to FIGS. 10 and 11.

FIG. 10 is an apparatus for an automatic horizontal movement of a movable object utilizing the gravitation force as disclosed in the U.S. patent application Ser. No. 09/910,693 by the same inventor that could be brought in to operate in tandem with the floating apparatus of the present invention for further enhancement of the benefit derived from each apparatus to their fullest potential.

As shown in FIG. 11 the association of the gravitation apparatus of FIG. 10 and the floating apparatus of the present invention is made through the connection between large wheel 41 of the gravitation apparatus of FIG. 10 and sprocket GV of the floating apparatus of the present invention. Also, chain or sling 21 of the gravitation apparatus has one of its ends connected to the fixing dent 31 on wheel PV of the floating apparatus as shown. Due to the sliding action of mass M1 on platform 9 of slider 101 and its associate sling 21 and pulleys 27 of the gravitation apparatus as disclosed in the previously-mentioned U.S. patent application of the same inventor, sprocket GV of the floating apparatus of the present invention originally in a state as shown in FIG. 3 will be forced to make a turn, concurrently, with the revolving action of the floating apparatus. Therefore, with the individual action of each apparatus complimenting each other as explained herewith, sprocket GV of the floating apparatus will drive sprocket 441 of wheel 41 on the gravitation apparatus to make a turn in the direction W1 as shown in the drawing in order to force, through its associate hub 71, arm 51, and hub 81, the raising of platform 9 of the following slider 101 to begin the sliding movement of mass M1 of the gravitation apparatus arranged in a closed-loop fashion as already disclosed in the said U.S. patent application. And at the same time the floating tandem unit in accordance with the present invention, which is being in a position as shown in FIG. 6 and ready to be tilted, will be triggered by the action of the gravitation apparatus to make the next revolution within the liquid-filled container. This complimenting action between the two associate apparatus as shown and explained herein will keep the revolution of the floating device in accordance with the present invention goes on indefinitely.

Even though the embodiments in accordance with the present invention has been clearly explained in reference to the drawings it is still within the scope of the present invention to propose some variations to them. For instance, the size and the design of the large and small floating devices and perforated tubes could be altered from the ones shown herein. Also, there is no limitation whatsoever on the material used in this invention as long as all the objectives of the present invention are fully met.

1. A method for the utilization of the buoyancy principle in providing an automatic revolution of a floating apparatus by means of obtaining a coordinated balancing status between two floating devices of larger and smaller sizes sharing a common pivotal axis for the revolution in a vertical direction of the whole unit.

2. A method as claimed in claim 1, wherein the said larger and smaller floating devices are arranged to operate in tandem.

3. A method as claimed in claims 1 and 2, wherein the said smaller floating device tilts the balancing status of the larger floating device in order to generate the continuous revolution of the whole unit.

4. A method as claimed in claims 1-3, wherein the automatic revolution is made in a vertical direction.

5. A method as claimed in claims 1-4, wherein the automatic revolution is made under a submerged condition.

6. An apparatus for the utilization of the buoyancy principle in providing an automatic revolution of a tandem floating devices, wherein each one of the said devices comprising a lighter end and a heavier end, and both of which being installed inside a liquid-filled container for free rotation in the vertical direction.

7. An apparatus for the utilization of the buoyancy principle in providing an automatic revolution of a tandem floating devices, wherein the said floating devices are contained within an individual perforated tube.

8. An apparatus as claimed in claims 6 and 7, wherein the said perforated tubes are connected to each other via a common pivotal axis on the respective outer wall along the length of the said perforated tubes at a predetermined location.

9. An apparatus as claimed in claims 6-8, wherein the said tandem floating devices comprise of a larger unit and a smaller unit, both of which have the same length and the same general design.

10. An apparatus as claimed in claims 6-9, wherein the balancing status of the larger floating device is being tilted to make a revolution in the vertical direction by the coordinated action of the smaller floating device.

11. An apparatus as claimed in claims 6-10, wherein the floating capacity of the floating device' lighter ends has been appropriately set in order to keep the respective floating device in a submerged condition when put under a natural buoyancy state.

12. A method and an apparatus as claimed in claims 1-11, wherein the vertical revolution of the floating devices is in a predetermined direction.
